(19) United States
(12) Patent Application Publication
(10) Pub. No.: US 2008/0203333 A1
(43) Pub. Date: Aug. 28, 2008

(54) SHEET DISCRIMINATION APPARATUS AND IMAGE FORMING APPARATUS

(75) Inventor: Katsuya Endo, Fuji-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/678,190

(22) Filed: Feb. 23, 2007

(51) Int. Cl. G01B 11/06; G01N 21/86; G01V 8/00

(52) U.S. Cl. 250/559.27

(57) ABSTRACT

Light is irradiated from obliquely below to an end of a sheet conveyed. The light is received by plural light receiving elements arranged at predetermined intervals above the sheet to discriminate the thickness of the sheet. Image forming conditions of an image forming apparatus are changed according to a result of the discrimination to obtain a satisfactory image quality.

### BACKGROUND OF THE INVENTION

1. Field of the Invention

The present invention relates to a sheet discrimination apparatus that performs discrimination on the basis of a sheet thickness and an image forming apparatus mounted with the sheet discrimination apparatus.

2. Description of the Related Art

In an image forming apparatus, for example, in an electrophotographic system, a heat quantity necessary for a sheet is different for each thickness in a fixing process for heating and pressing a toner transferred onto a recording material as a sheet and fixing the toner on the sheet. Therefore, it is necessary to control fixing conditions such as temperature during fixing on the basis of the thickness of the sheet.

In a color copying machine that superimposes four colors of toners (developing agents) one on top of another on one sheet (transfer material) to form one image, a quantity of toner placed on the sheet is relatively large compared with a monochrome copying machine. Thus, a difference in the thickness of a sheet substantially affects an image quality. Therefore, in a general fixing device of a heating system for melting and fixing a toner, a heat quantity deprived by a sheet during fixing is larger and, therefore, a heat quantity served for the melting of the toner is smaller as the thickness of the sheet is larger. Consequently, in a color image with a large quantity of toner, since the toner is not sufficiently melted, fixing failure tends to occur. In order to prevent such fixing failure, in particular, precise temperature management is required in the color copying machine compared with the monochrome copying machine.

In a transfer process for transferring a toner onto a sheet, when the thickness of the sheet is different, a volume resistance is different. Thus, it is necessary to change a transfer current for driving a transfer charger according to the thickness of the sheet.

Therefore, for example, it is preferable that a user sets a size and a type of a sheet (hereinafter referred to as “sheet type”) on an operation panel or the like provided in an image forming apparatus main body and transfer conditions or fixing conditions, for example, a fixing temperature and conveying speed of the sheet passing through the fixing device are controlled according to the setting.

Instead of the setting of a type of a sheet by the user, a method of automatically discriminating a type of a sheet is proposed. In this method, a sensor that discriminates a sheet according to reflected light is disposed in the inside of an image forming apparatus and transfer conditions, fixing conditions, or the like are variably controlled according to the type of the sheet discriminated.

There is also proposed an apparatus that is provided with a light emission source in a position opposed to a sensor, which discriminates a type of a sheet, and detects transmitted light to perform discrimination of a sheet according to the transmitted light. For example, the apparatus adopts a system for imaging a surface image of a sheet with a CCD sensor and converting information on this surface image into fractal dimensional information to detect surface smoothness of the sheet and a method of imaging a surface image of a sheet with a CCD sensor or a CMOS sensor, detecting roughness of the sheet from a relation of levels of light, and discriminating a sheet type from surface smoothness (JP-A-2002-182518).

There is also disclosed an apparatus that is provided with a light emission source in a position opposed to a sensor, which discriminates a sheet, and detects transmitted light to discriminate the thickness of a recording sheet according to the transmitted light (JP-A-2005-128004).

However, a degree of freedom of installation is limited in arranging the sheet discrimination apparatus described above in an image forming apparatus. Thus, it is not easy to reduce a size of the apparatus.

### BRIEF SUMMARY OF THE INVENTION

It is an object of the invention to provide a sheet discrimination apparatus that discriminates a sheet on the basis of the thickness of the sheet.

In an aspect of the present invention, a sheet discrimination apparatus that discriminates a type of a sheet, on which an image is formed, on the basis of the thickness of the sheet includes a setting unit that sets a predetermined position near a front end of a sheet conveyed thereto, a light emitting unit that is disposed further downstream in a conveying direction than the predetermined position set by the setting unit and irradiates light on the end from below the sheet, plural light receiving units that are disposed at predetermined intervals further upstream in the conveying direction than the predetermined position and above the sheet and receive light irradiated from the light emitting unit, and a discriminating unit that discriminates a type of the sheet from light receiving states of the respective light receiving units.

### DESCRIPTION OF THE DRAWINGS

FIG. 1 is a diagram showing an example of an image forming apparatus;

FIG. 2 is a block diagram showing a structure of a main part of a control system of the image forming apparatus in FIG. 1;

FIG. 3A is a side view of a sheet discrimination apparatus according to an embodiment of the invention;

FIG. 3B is a plan view of the sheet discrimination apparatus according to the embodiment of the invention; and

FIG. 4 is a plan view showing a modification of the sheet discrimination apparatus according to the embodiment of the invention.

### DETAILED DESCRIPTION OF THE INVENTION

Throughout this description, the embodiments and examples shown should be considered as exemplars, rather than limitations on the apparatus and methods of the present invention.

An embodiment of an image forming apparatus according to the invention will be hereinafter explained in details using the drawings.

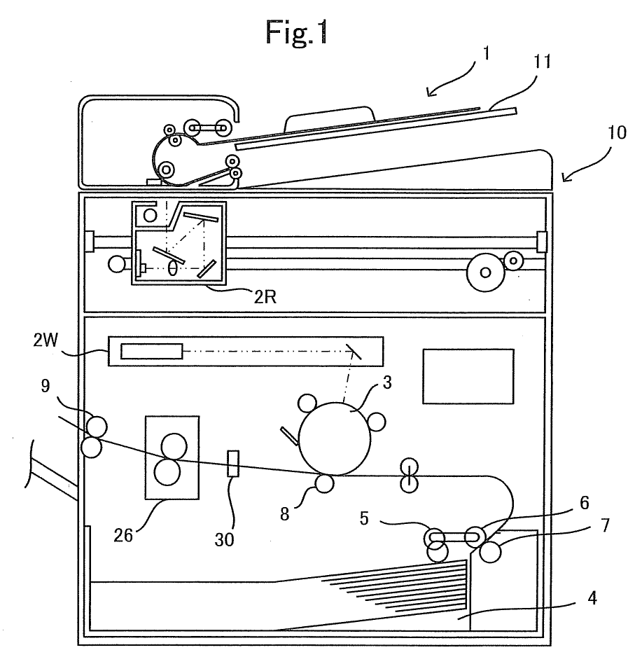

FIG. 1 is a diagram showing the embodiment of the image forming apparatus. An image forming apparatus 10 has an ADF (Auto Document Feeder) 1 that automatically feeds an original inserted by a user, an image scanning device (hereinafter referred to as a scanner unit) 2R that applies image scanning to an original placed on an original placing stand 11 of this ADF 1 and sent from the original placing stand 11, and a photoconductive drum (a latent image bearing member) 3 on which a laser beam is irradiated according to a recording signal after image processing is applied to an image scanned by this image scanning device 2R. A latent image is formed by irradiating a laser beam on this photoconductive drum 3 with a laser scanner (exposing means) 2W for image writing.

The image forming apparatus 10 has a cassette 4 that stores sheets (recording media) such as paper or films and a pickup roller 5, a conveying roller 6, and a separating roller 7 for conveying the sheets to the photoconductive drum 3. The sheets stored in the cassette 4 are picked up by the pickup roller 5 according to a recording signal. The sheets are supplied to a position opposed to the photoconductive drum 3 one by one by the conveying roller 6 and the separating roller 7.

Moreover, the image forming apparatus 10 has a transferring device 8 that transfers a toner image, which is formed by developing means using a toner supplied from a not-shown toner supplying device, onto a sheet, a fixing device 26 that fixes the toner image transferred onto the sheet, a sheet discrimination apparatus 30 that is arranged on a conveying path for a sheet on an upstream side (a sheet feeding side) of the fixing device 26, detects the thickness of the sheet, and discriminates the sheet according to a result of the detection, a discharging roller 9 that is provided on a downstream side of the fixing device 26 and discharges the sheet, on which fixing of the toner image is completed, to a discharge tray set outside the image forming apparatus 10, and the like.

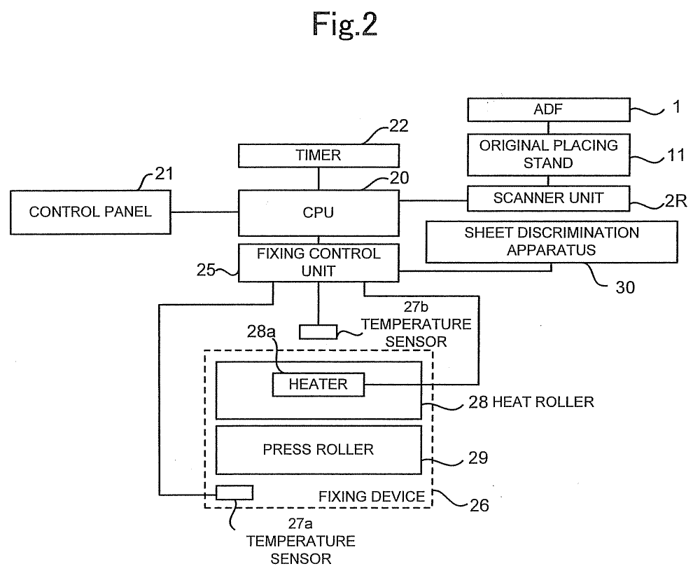

FIG. 2 is a block diagram showing a structure of a main part of a control system of the image forming apparatus 10.

The control system of the image forming apparatus 10 includes a CPU (Central Processing Unit) 20, a control panel 21, a timer 22, the ADF 1, the scanner unit 2R, a fixing control unit 25, and the fixing device 26. Moreover, the fixing device 26 has temperature sensors 27a and 27b, a heat roller 28 having a heater 28a built therein, and a press roller 29.

The CPU 20 controls operations of the entire image forming apparatus 10 and is connected to the control panel 21, the timer 22, the scanner unit 2R, and the fixing control unit 25. The CPU 20 and the fixing control unit 25 constitute a control unit that controls all the operations.

The fixing control unit 25 performs control concerning setting of a fixing temperature of the fixing device 26 and fixing power to be supplied and the like on the basis of a result of detection by the sheet discrimination apparatus 30.

In the fixing device 26, the temperature sensor 27b is arranged near the heat roller 28 heated by the heater 28a , detects temperature of the heat roller 28, and notifies the fixing control unit 25 of the temperature.

The temperature sensor 27a is arranged near the press roller 29, detects temperature of the press roller 29, and notifies the fixing control unit 25 of the temperature.

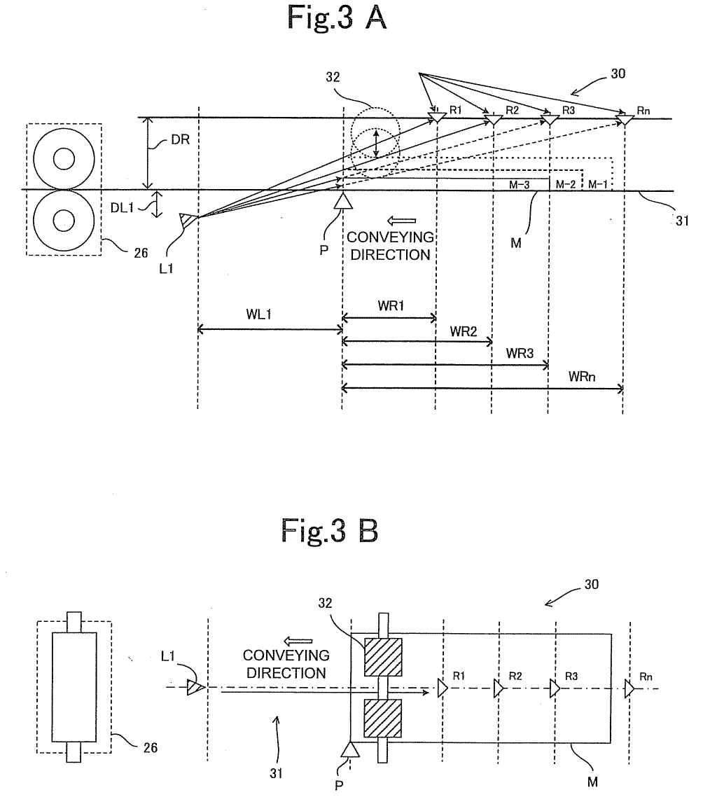

The sheet discrimination apparatus 30 will be explained. FIG. 3A is a side view of the sheet discrimination apparatus 30 and FIG. 3B is a plan view thereof.

A sheet thickness detection position P is set in the sheet discrimination apparatus 30 as a translucent region provided substantially in the center of the conveying path 31 for a sheet M on the upstream side (the sheet feeding side) of the fixing device 26. A light emitting element L1 is arranged below the conveying path 31 near the sheet thickness detection position P to irradiate light on the conveying path 31 at a predetermined angle. As the light emitting element L1, it is possible to use, for example, an infrared LED that is less easily affected by external light from the surroundings. On the other hand, across the sheet conveying path 31, plural light receiving elements R1, R2, R3, and Rn are arranged on an upper side of the conveying path 31 to be inclined at a predetermined angle and spaced apart at predetermined intervals such that light of the light emitting element L1 can be received at substantially in front thereof. Here, n corresponds to a type of the sheet M to be discriminated.

An arrangement of the respective units for measurement of paper thickness is as follows. The light emitting element L1 is arranged in a position a distance WL1 downstream (in a conveying direction) on the conveying path 31 from the sheet thickness detection position P and a distant DL 1 below a conveying surface of the conveying path 31. On the other hand, the light receiving elements R1, R2, R3, and Rn are arranged in positions upstream (in the conveying direction) on the conveying path 31 from the sheet thickness detection position P and a distance DR above the conveying surface of the conveying path 31. The light receiving elements R1, R2, R3, and Rn are arranged in positions distances WR1, WR2, WR3, and WRn apart from the sheet thickness detection positions P, respectively. The respective light receiving elements R1, R2, R3, and Rn have physical sizes. DL1 is set smaller than DR. By setting the distances in this way, it is possible to set intervals of the respective arrangement positions WR1, WR2, WR3, and WRn of the light receiving elements R1, R2, R3, and Rn large compared with a difference of sheet thicknesses to be discriminated. For example, it is possible to enlarge a difference of 0.05 mm of sheet thicknesses to 3 to 4 mm or more as an interval between WR1 and WR2. It is also possible to improve accuracy of discrimination by providing slits or the like near the light receiving elements R1, R2, R3, and Rn, respectively, and stopping light received.

In the case of detection of the thickness of the sheet M, the sheet M conveyed on the conveying path 31 is stopped in the sheet thickness detection position P and pressed by a sheet pressing roller 32. In that state, the thickness of the sheet M is detected. When an end of the sheet M lifts, it is impossible to detect the thickness of the sheet M highly accurately. Thus, it goes without saying that it is essential to perform adjustment of the sheet pressing roller 32 sufficiently. It is also important to convey the sheet M such that the end of the sheet M is not damaged.

With the structure and the arrangement described above, when the sheet M arrives at the sheet thickness detection position P, the sheet discrimination apparatus 30 detects by which of the light receiving elements R1, R2, R3, and Rn light irradiated on the conveying path 31 from the light emitting element L1 is being selectively received without being blocked by the thickness of an end face of the sheet M. It is possible to determine the thickness of the sheet and discriminate a type of the sheet M by comparing a result of the detection with known data stored in advance.

For example, when the light receiving elements R1 and R2 are ON and the light receiving elements R3 and Rn are OFF, it is possible to discriminate that the sheet M being conveyed is a sheet having thickness of a rank of M-1 (which is a provisional code and is not a standard of a type of a sheet). Similarly, when the light receiving element R1 is ON and the light receiving elements R2, R3, and Rn are OFF, it is possible to discriminate that a sheet of a rank of M-2 is being conveyed. It goes without saying that a light receiving amount of a light receiving element may be converted into a current amount to perform discrimination of a type.

By obliquely irradiating light on the sheet M, it is possible to amplify and obtain blocking of the light by the thickness of the sheet M and grasp a slight change in the thickness of the sheet M as a large change.

It is possible to further improve accuracy of detection of the thickness of the sheet M by disposing plural elements having high linearity such as laser diodes as the light emitting element L1 corresponding to a type of the sheet M to be discriminated and detecting presence or absence of blocking of laser beams with the light receiving elements R1, R2, R3, and Rn corresponding to the elements.

According to the sheet discrimination apparatus 30 according to this embodiment, it is possible to discriminate the thickness of a sheet with a simple structure. Moreover, it is possible to accurately perform ranking of thicknesses of sheets. Consequently, it is possible to perform setting of fixing conditions and transfer conditions and conveyance control corresponding to the thickness of a sheet and the image forming apparatus can obtain a satisfactory image quality.

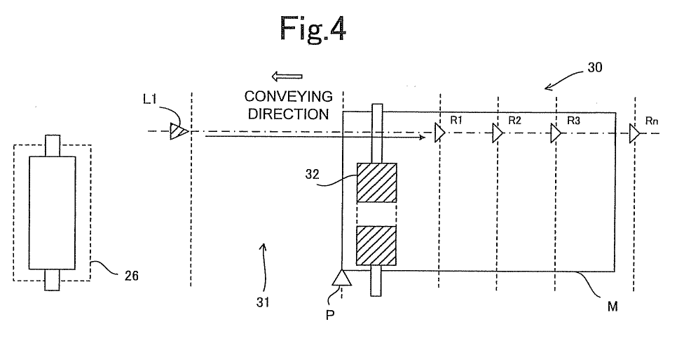

FIG. 4 is a plan view showing a modification of the sheet discrimination apparatus 30. In this modification, a sheet thickness detection position is arranged at an end of the conveying path 31 rather than substantially in the center of the conveying path 31. Otherwise, the sheet discrimination apparatus 30 is the same as the sheet discrimination apparatus 30 shown in FIGS. 3A and 3B. Thus, the identical functional components are denoted by the identical reference numerals and signs and explanations of the components are omitted.

In the case described above, as a shape of the sheet pressing roller 32, a roller section is divided into two parts in order to transit light from the light emitting element. However, in the case of this modification, the sheet pressing roller 32 does not have to be divided into two parts in order to transmit light from the light emitting element. It goes without saying that light may be irradiated at the end in front on the right side of the sheet M or may be irradiated at the end in front on the left side of the sheet M.

It is possible to determine a shape and a disposed location of the sheet pressing roller 32 as appropriate as long as the end of the sheet M is not damaged and lifting of the sheet M can be prevented.

In the case of this modification, as in the embodiment, it is possible to constitute a detecting unit for the thickness of the sheet with an inexpensive element. Moreover, it is possible to accurately perform ranking of thicknesses of sheets. This makes it possible to perform fixing control corresponding to the thickness of a sheet. Thus, fixing properties are improved and the image forming apparatus can obtain a satisfactory image quality.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. A sheet discrimination apparatus that discriminates a sheet, on which an image is formed, on the basis of thickness of the sheet, comprising:
a setting unit configured to set a predetermined position near a front end of a sheet conveyed thereto;
a light emitting unit configured to be disposed further downstream in a conveying direction than the predetermined position set by the setting unit and irradiate light on the end from below the sheet;
plural light receiving units configured to be disposed at predetermined intervals further upstream in the conveying direction than the predetermined position and above the sheet and receive light irradiated from the light emitting unit; and
a discriminating unit configured to discriminate a type of the sheet from light receiving states of the respective light receiving units.

2. A sheet discrimination apparatus according to claim 1, wherein the light emitting unit adopts an infrared LED as a light emitting element.

3. A sheet discrimination apparatus according to claim 1, wherein the light emitting unit adopts a laser diode as a light emitting element.

4. A sheet discrimination apparatus according to claim 1, wherein a light emitting element of the light emitting unit and light receiving elements of the light receiving units are disposed substantially opposed to each other.

5. A sheet discrimination apparatus according to claim 1, wherein light receiving elements of the light receiving unit are surrounded by slits to stop and receive light from one direction.

6. An image forming apparatus mounted with a sheet discrimination apparatus according to any one of claims 1 to 5.

7. An image forming apparatus according to claim 6, image forming conditions are associated with a type of the sheet obtained as a result of discrimination.

8. A sheet discrimination apparatus that discriminates a sheet, on which an image is formed, on the basis of thickness of the sheet, comprising:
a light emitting element that emits light from a front bottom end to a rear top end of a sheet conveyed thereto;
a light receiving element that receives, in a position at the rear top end, the light irradiated from this light emitting element;
a measuring unit configured to measure thickness of the sheet from information on light reception of the light receiving element; and
a discriminating unit configured to discriminate a type of a sheet conveyed thereto according to a result of the measurement of this measuring unit.

9. A sheet discrimination apparatus according to claim 8, wherein a plurality of the light receiving elements are arranged in a conveying direction of the sheet.

10. A sheet discriminating method of discriminating a sheet, on which an image is formed, on the basis of thickness of the sheet, comprising:
irradiating light from a front bottom end to a rear top end of a sheet conveyed;
receiving, in a position at the rear top end, this light irradiated;
measuring thickness of the sheet from information on this light reception; and
discriminating a type of a sheet conveyed from a result of this measurement.

11. A sheet discriminating method of discriminating a sheet, on which an image is formed, on the basis of thickness of the sheet, comprising:
setting a predetermined position near a front end of a sheet conveyed;
irradiating light on the end from further downstream in a conveying direction than the predetermined position and below the sheet;
receiving light further upstream in the conveying direction than the predetermined position and above the sheet; and
discriminating a type of the sheet from a state of the light reception of the light.

12. A sheet discriminating method of discriminating a sheet, on which an image is formed, on the basis of thickness of the sheet, comprising:
setting a predetermined position near a front end of a sheet conveyed;
irradiating light on the end from further downstream in a conveying direction than the predetermined position and below the sheet;
receiving light further upstream in the conveying direction than the predetermined position and above the sheet;
measuring thickness of the sheet from information on this light reception; and
discriminating a type of a sheet conveyed from a result of this measurement.
